(19) United States
(12) Patent Application Publication
(10) Pub. No.: US 2015/0233541 A1
(43) Pub. Date: Aug. 20, 2015

(54) LIGHT SOURCE MODULE

(71) Applicant: GLOBAL MICROPTICS CO., LTD., Tainan (TW)

(72) Inventor: Tsung-Chieh CHANG, Tainan (TW)

(73) Assignee: GLOBAL MICROPTICS CO., LTD., Tainan (TW)

(21) Appl. No.: 14/182,093

(22) Filed: Feb. 17, 2014

(51) Int. Cl. F21V 5/04; F21K 99/00

(52) U.S. Cl. CPC F21V 5/048; F21K 9/50; F21Y 2101/02

(57) ABSTRACT

A light source module includes a lighting member and an optical member. The optical member is transparent and is made of a light curable material or a thermosetting material. The optical member covers the lighting member. The optical member has a first optical layer and a second optical attached to the first optical layer. A refractive index of the first optical layer is greater than 1, and a refractive index of the second optical layer is greater than 1 and is not identical to the refractive index of the first optical layer.

### BACKGROUND OF THE INVENTION

1. Technical Field

The present invention relates generally to a light source, and more particularly to a light source module, which emits light with a large divergence angle.

2. Description of Related Art

As the improvement of technology, light source modules, which are powered by electricity, are widely used for illumination in ordinary life. In recent days, LED (light emitting diode) module is the commonest light source module in the market.

FIG. 1 shows a conventional LED module 2, including a lighting member 30 (LED) and an optical member 40 attached to the lighting member 30 to diverge the light of the lighting member 30. The conventional optical member 40 usually is a single-layered diverging lens. Light enters the diverging lens via an enter surface Sin, and leaves via an exit surface Sout, and a divergence angle of such diverging lens usually is less than 120 degrees. It is not wide enough for the modern need of the light source module.

### BRIEF SUMMARY OF THE INVENTION

In view of the above, the primary objective of the present invention is to provide a light source module, which emits light with a large divergence angle.

The present invention provides a light source module, including a lighting member and an optical member. The optical member is transparent and is made of a light curable material or a thermosetting material. The optical member covers the lighting member. The optical member has a first optical layer and a second optical attached to the first optical layer. A refractive index of the first optical layer is greater than 1, and a refractive index of the second optical layer is greater than 1 and is not identical to the refractive index of the first optical layer.

In an embodiment, the refractive indexes of the first optical layer and the second optical layer are in a range between 1.2 and 2.0.

In an embodiment, a difference of the refractive indexes of the first optical layer and the second optical layer is in a range between 0.01 and 0.5.

In an embodiment, curvatures of surfaces of first optical layer and the second optical layer which are attached to each other are different from a curvature of a surface of the first optical layer which faces the light member.

In an embodiment, curvatures of surfaces of the first optical layer and the second optical layer which are attached to each other are different from a curvature of a surface of the second optical layer which faces outside of the light source module.

In an embodiment, an air medium is formed between the light member and the first optical layer.

In an embodiment, a difference of the refractive index of the first optical layer and a refractive index of the air medium is in a range between 0.1 and 1.0.

With the aforementioned design, the light source module of the present invention may have a large light diverging capacity to emit light in a wide angle.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch diagram of the conventional light source module;

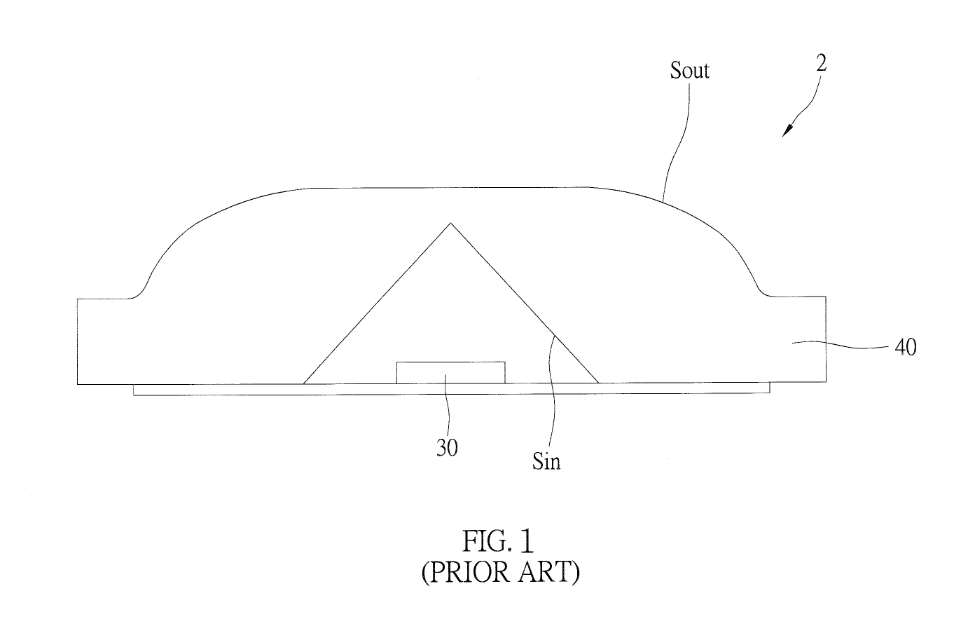

FIG. 2 is a sketch diagram of a preferred embodiment of the present invention;

### DETAILED DESCRIPTION OF THE INVENTION

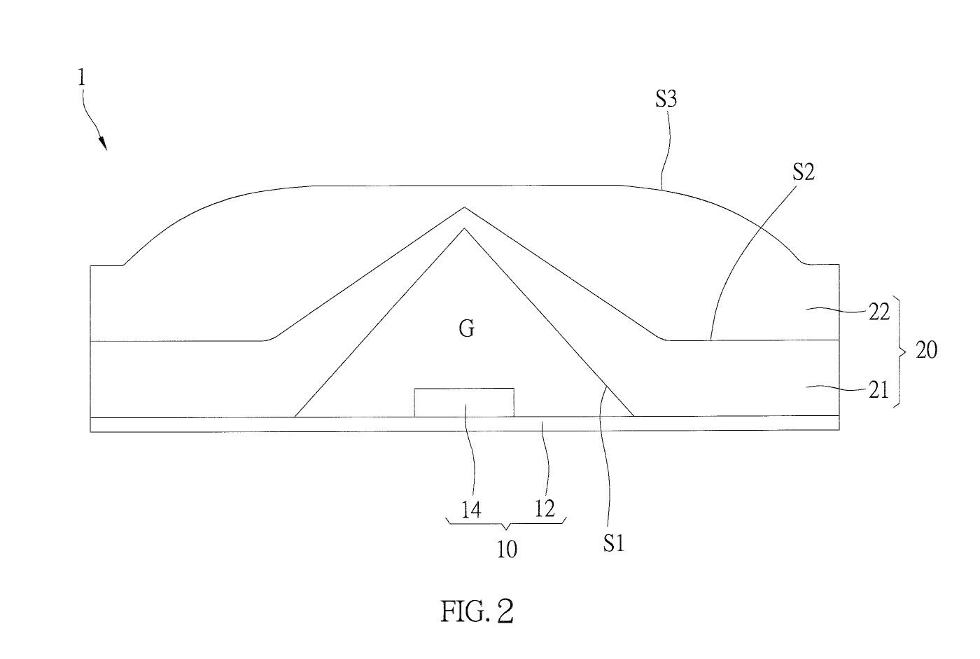

As shown in FIG. 2, a light source module 1 of the preferred embodiment of the present invention includes a lighting member 10 and an optical member 20.

The lighting member 10 has a substrate 12 and a LED (light emitting diode) chip 14 mounted on the substrate 12. The LED chip 14 is powered by electricity to emit light. In practice, except for the LED chip 14, any lighting device may be used in the present invention.

The optical member 20 is transparent, and is mounted on the substrate 12 to cover the LED chip 14. A space is formed between the LED chip 14 and the optical member 20, and the space is filled with air. In other words, an air medium G is formed between the LED chip 14 and the optical member 20. The optical member 20 has a first optical layer 21 and a second optical layer 22 attached to the first optical layer 21 by adhesive or other means, wherein the first optical layer 21 is proximal to the LED chip 14. In an embodiment, the first and the second optical layers 21 and 22 are made of epoxy, which is self-adhesive and UV curable. The second optical layer 22 is attached to the first optical layer 21 while the second optical layer 22 is being solidified, or the first optical layer 21 is attached to the second optical layer 22 while the first optical layer 21 is being solidified. Refractive indexes of the first and the second optical layers 21 and 22 are greater than one, and the refractive index of the first optical layer 21 is not equal to that of the second optical layer 22. In an embodiment, the refractive indexes of the first and the second optical layers 21 and 22 are in a range between 1.2 and 2.0, and a difference of the refractive indexes of the first and the second optical layers 21 and 22 is in a range between 0.01 and 0.5. A difference of the refractive index of the first optical layer 21 and a refractive index of the air medium G is in a range between 0.1 and 1.0. Except epoxy, any light curable or thermosetting material may be used to mold the first and the second optical layers 21 and 22.

Besides, surfaces S2 of the first and the second optical layers 21 and 22 which are attached to each other have complementary curvatures, which mean no gap between the surfaces S2. The curvatures of the surfaces S2 are different from that of a surface S1 of the first optical layer 21 which faces the LED chip 14 and that of a surface S3 of the second optical layer 22 which faces outside of the light source module 1. With these characters, the optical member 20 may have a large light diverging capacity to diverge light in a wide angle.

As a result, the double-layered optical member 20 may have a divergence angle in a range between 165 degrees and 170 degrees to enlarge the range where the light source module 1 may illuminate.

It must be pointed out that the embodiments described above are only some preferred embodiments of the present invention. All equivalent structures and methods which employ the concepts disclosed in this specification and the appended claims should fall within the scope of the present invention.

What is claimed is:

1. A light source module, comprising:
a lighting member; and
an optical member, which is transparent and is made of a light curable material or a thermosetting material, covering the lighting member, wherein the optical member has a first optical layer and a second optical layer attached to the first optical layer; a refractive index of the first optical layer is greater than 1, and a refractive index of the second optical layer is greater than 1 and is not identical to the refractive index of the first optical layer.

2. The method of claim 1, wherein the refractive indexes of the first optical layer and the second optical layer are in a range between 1.2 and 2.0.

3. The light source module of claim 1, wherein a difference of the refractive indexes of the first optical layer and the second optical layer is in a range between 0.01 and 0.5.

4. The light source module of claim 1, wherein curvatures of surfaces of first optical layer and the second optical layer which are attached to each other are different from a curvature of a surface of the first optical layer which faces the light member.

5. The light source module of claim 1, wherein curvatures of surfaces of the first optical layer and the second optical layer which are attached to each other are different from a curvature of a surface of the second optical layer which faces outside of the light source module.

6. The light source module of claim 1, wherein an air medium is formed between the light member and the first optical layer.

7. The light source module of claim 6, wherein a difference of the refractive index of the first optical layer and a refractive index of the air medium is in a range between 0.1 and 1.0.

8. The light source module of claim 1, wherein the lighting member includes a substrate and a LED chip mounted on the substrate, and the optical member is mounted on the substrate and covers the LED chip.

9. The light source module of claim 1, wherein surfaces of first optical layer and the second optical layer which are attached to each other have complementary curvatures.

10. The light source module of claim 1, wherein one of the first optical layer and the second optical layer is made of a self-adhesive material to be attached to the other one while the self-adhesive material is being solidified.
